(19) United States
(12) Patent Application Publication
(10) Pub. No.: US 2025/0257849 A1
(43) Pub. Date: Aug. 14, 2025

(54) CONNECTOR DEVICE FOR A HIGH-PRESSURE HYDROGEN RESERVOIR, HIGH-PRESSURE HYDROGEN STORAGE FUEL CELL SYSTEM, AND METHOD OF PRODUCING A CONNECTOR DEVICE FOR A HIGH-PRESSURE HYDROGEN RESERVOIR

(71) Applicant: Robert Bosch GmbH, Stuttgart (DE)

(72) Inventors: Jerome Pedron, Heyrieux (FR); Eric Bernadac, St. Priest (FR)

(21) Appl. No.: 18/855,143

(22) PCT Filed: Apr. 6, 2023
(86) PCT No.: PCT/EP2023/059085

§ 371 Date: Oct. 8, 2024

(30) Foreign Application Priority Data
Apr. 28, 2022 (EP) 22170565.0

(51) Int. Cl. F17C 13/00; F16L 39/00; H01M 8/04082

(52) U.S. Cl. CPC F17C 13/00; F16L 39/00; H01M 8/04216; F17C 2205/037; F17C 2209/23; F17C 2221/012; F17C 2223/035; F17C 2270/0168; F17C 2270/0184

(57) ABSTRACT

The invention relates to a connector device for connecting one or more hydrogen storage means to a fuel cell. For this purpose, a connector device is proposed which has a main part made of a light metal, such as aluminum, and connector elements made of a high-strength material, such as high-grade steel.

### BACKGROUND

The present invention relates to a connector device for a high-pressure hydrogen reservoir, a high-pressure hydrogen storage means, as well as a fuel cell system. The present invention further relates to a method of producing a connector device for a high-pressure hydrogen reservoir.

Fuel cell units are able to generate electrical energy from continuously supplied fuel and an oxidizer by means of redox reactions at an anode and a cathode. In this context, hydrogen can, e.g., be supplied in an anode path, and atmospheric oxygen can simultaneously be supplied in a cathode path. In a fuel cell stack, hydrogen is oxidized by the supplied atmospheric oxygen, whereby electrical energy can be obtained.

Publication DE 10 2017 212 485 A1 describes a device for storing compressed fluids for a vehicle, in particular for storing hydrogen for a fuel cell vehicle.

### SUMMARY

The present invention provides a connector device for a high-pressure hydrogen reservoir, a high-pressure hydrogen storage means, a fuel cell system, and a method of producing a connector device for a high-pressure hydrogen reservoir having the features of the disclosure.

The following is therefore provided:
a connector device for a high-pressure hydrogen reservoir having a main part and at least one connector element. The main part is made of aluminum, an aluminum alloy, or another light metal. The connector element is made of steel, in particular high-grade steel. The main part comprises a connector opening that extends radially to the flow channel. The at least one connector element is in this case arranged in the connector opening of the main part.

The following are furthermore provided:
a high-pressure hydrogen storage means having a connector device according to the present invention and at least one high-pressure hydrogen reservoir. Each high-pressure hydrogen reservoir is in this case releasably connected to the connector device on a connector element.

The following is furthermore provided:
a fuel cell system having a high-pressure hydrogen storage means and a fuel cell device according to the present invention. The fuel cell device is in this case connected to the high-pressure hydrogen storage means.

Finally, the following is provided:
a method of producing a connector device for a high-pressure hydrogen reservoir. The method comprises a step of providing a main part. The main part is made of aluminum, an aluminum alloy, or another light metal. In particular, the main part comprises a flow channel and at least one connector opening that extends radially to the flow channel. The method further comprises a step of inserting at least one connector element into the at least one connector opening of the main part. The connector element is in this case made of steel, in particular high-grade steel or another high-strength material.

The present invention is based on the recognition that fuel cell systems obtain their fuel, i.e. hydrogen, from a tank system that can store the hydrogen under a high pressure of up to 700 bar. This tank system can in particular comprise a plurality of individual reservoirs. A connection between the individual reservoirs and the fuel cell system is necessary in this case.

According to the applicable regulations, this connection must still have a sufficient tightness and pressure resistance, even after repeated loosening and reconnection.

Such requirements therefore require a connector element made of a high-strength material that does not exhibit any wear that could adversely affect the tightness, even after repeated loosening and reconnection. However, such materials typically have a high specific weight and are also relatively difficult to process.

It is therefore an idea of the present invention to take this realization into account and to create a connector device for a high-pressure hydrogen storage means which, on the one hand, is easy to manufacture and also has as low a weight as possible, but on the other hand also meets the requirements for sufficient tightness after repeated loosening and reconnection.

For this purpose, it is provided according to the invention that such a connector device is produced from a main part and additional connector elements. The main part can be produced from a lightweight material, such as aluminum or an aluminum alloy. This can, e.g., be in the form of a casting process, so that this main part can be easily provided as a cast part. The connector elements made of a high-strength material, such as steel, in particular high-grade steel, can then be attached in or to this main part. Given that this connection between the main part and the connector element is typically only performed once during the manufacturing process, the requirements for such a connection are lower than the requirements for a connection to external components which are intended to be repeatedly loosened.

Given that the connector element itself is made of a high-strength material such as high-grade steel, further components such as supply lines, valves, or the like can be connected to this connector element, whereby a sufficient stability for a pressure-resistant and gas-tight connection can be ensured, even after repeated loosening and reconnection.

Since only the relatively small connector elements for the connector device according to the invention are made of the high-strength material, such as high-grade steel, and the substantially larger main part can be made of a lightweight material, such as aluminum, the total weight of the connector device is significantly lower than that of a comparable connector device made entirely of a high-strength material. In addition, a lightweight material such as aluminum can, e.g., be processed much easier than high-grade steel. It is therefore much easier to manufacture such a main part.

In this context, it is understood that suitable materials must be selected for both the main part and the connector elements of the connector device according to the invention, which meet the requirements regarding pressure resistance and in particular also resistance to the gases flowing through, in this case hydrogen.

According to one embodiment, the main part comprises an aluminum cast part. Such cast parts are very simple to produce with high precision, especially in large quantities. It is therefore possible to realize the connector device according to the invention cost-effectively and in high quality.

According to one embodiment, the at least one connector opening comprises a thread, in particular an inner thread. In this case, the at least one connector element is screwed into the connector opening. Accordingly, the connector element comprises a corresponding external thread. The connector element can thus be screwed into the main part in a simple manner. This enables simple, fast and cost-efficient manufacturing.

According to one embodiment, the at least one connector element comprises a sealing portion. This sealing portion rests upon an outer side of the connector element when the connector element is screwed in. In this way, the tightness of the connection between the connector element and the main part can additionally be increased by this sealing portion.

According to one embodiment, the thread in the connector opening of the main part has a conical shape. In particular, a diameter of the thread in the area of the outer side of the connector element is greater than a diameter of the thread in the area of the flow channel. Additionally or alternatively, the thread of the connector element, which is screwed into the connector opening, can also have a corresponding conical shape.

According to one embodiment, the at least one connector element is designed to be connected to a high-pressure hydrogen reservoir at a section facing away from the main part. For this purpose, the shape of the connector element can be designed accordingly to be connected to corresponding connector components of the hydrogen reservoir. For example, a corresponding thread can be provided for a connector element so that the connector element can be screwed to the corresponding components of the hydrogen reservoir. Given that the connector element is realized in this case from a high-strength material, such as high-grade steel, such a screw connection can ensure the required tightness even after repeated loosening and re-screwing.

The above embodiments and further developments can be combined with one another in any desired manner insofar as advantageous. Additional embodiments, further developments, and implementations of the invention also include inventive feature combinations not described or explicitly specified hereinabove or hereinafter with respect to exemplary embodiments. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings. Shown are:

FIG. 1: a schematic illustration of a fuel cell system having a connector device according to one embodiment;

FIG. 2: a schematic representation of a cross-section through a connector device according to one embodiment; and

FIG. 3: a flowchart as underlying a method of producing a connector device according to one embodiment.

### DETAILED DESCRIPTION

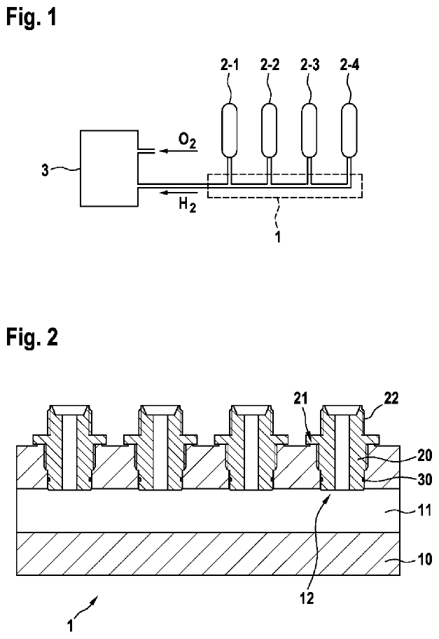

FIG. 1 shows a schematic illustration of a principle structure of a fuel cell system according to one embodiment. The fuel cell system shown in this case comprises, e.g., a fuel cell device 3. In this fuel cell device 3, hydrogen can be oxidized with oxygen, in particular air oxygen pressure. Electrical energy is produced thereby. This electrical energy can be used in a motor vehicle, e.g. for an electric drive.

The hydrogen required to operate the fuel cell system can be stored and provided in a hydrogen storage means.

In particular, the hydrogen can be stored at a high pressure, e.g. up to 700 bar. This hydrogen storage means can (as shown in FIG. 1) be formed from, e.g., one or more individual reservoirs 2-i. The number of four individual reservoirs 2-i shown in FIG. 1 serves in this case merely by way of example and does not represent a limitation of the present invention. The individual reservoirs 2-i can be connected to the fuel cell device 3 via a connector device 1. In particular, further components (not shown in this case) can be provided between the individual reservoirs 2-i and the connector device 1. For example, these further components can comprise valves, non-return valves, or further measurement, control, or safety components.

The individual reservoirs 2-i are in this case releasably connected to the connector device 1. For this purpose, a connector line of the individual reservoirs 2-i can, e.g., be screwed onto a corresponding component of the connector device 1.

FIG. 2 shows a schematic cross-section through a connector device 1 according to one embodiment. As can be seen in this case, the connector device 1 comprises a main part 10 as well as one or more connector elements 20.

The main part 10 comprises a flow channel 11 in the interior. This flow channel can be connected to the fuel cell device 3 to provide the required hydrogen to the fuel cell device 3.

The main part 10 further comprises one or more connector openings 12. These connector openings 12 extend at least approximately radially to the flow channel 11.

The main part 10 can be made of a light metal, such as aluminum or an aluminum alloy. For example, the main part 10 can be produced as a cast part in a simple manner with high precision. Alternatively, it is also possible to realize the main part 2 from a solid material block by inserting corresponding bores and further postprocessing.

Connector elements 20 are inserted into the main part 10, in particular in the connector openings 12. These connector elements 20 can be made of a high strength material such as steel, in particular high-grade steel.

The connector elements 20 can, e.g., be screwed into the connector openings 12. For this purpose, both the connector openings 12 and the connector element 20 can have a corresponding thread. This thread can, e.g., be a linear thread which has the same diameter at both an area on the outer side of the main part 10 and in the area of the flow channel 11. In this case, the tightness can, e.g., be ensured by means of an additional sealing element 30, for example an O-ring.

Alternatively, it is also possible that the threads of the connector element 20 and/or the thread in the connector openings 12 have a conical shape, whereby a diameter on the outer side of the main part 10 is greater than in an area on the flow opening 11.

Furthermore, the tightness of the connection between the main part 10 and the connector element 20 can be improved by a sealing portion 21 on the connector element 20. In particular, such a sealing portion 21 can be provided on the connector element 20 such that the sealing portion 21 rests flat upon the main part 10 when the connector element 20 is inserted into the main part 10.

In addition, a thread 22 can, e.g., be provided on an outer side of the part of the connector element 20 projecting from the main part 10. In this way, further components, e.g. corresponding connector components of the individual reservoirs 21-i or supply lines of the individual reservoirs 21-i, are screwed to the connector element 20. It is understood that the connector elements 20 can also comprise any other desired components and designs in order to connect the individual reservoirs 21-i or their supply lines to the connector element 20.

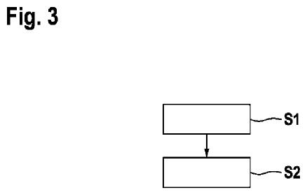

FIG. 3 shows a flowchart as a basis for a method of producing a connector device 1 according to one embodiment. The underlying connector device 1 can be the connector device 1 previously described. Accordingly, the method described below can comprise any desired steps required in order to manufacture the connector device 1 previously described.

In step S1, a main part 10 is first provided. This main part 1 can in particular be the previously described main part 1 made of a light metal, in particular aluminum or an aluminum alloy. This main part comprises a flow channel 11 and at least one connector opening 12 that extends radially to the flow channel 11.

In step S2, a connector element 20 is then inserted into the connector device openings 12 of the main part 1. These connector elements 20 can be made of a high strength material, such as steel, in particular high-grade steel. The insertion can, e.g., be performed by screwing the connector elements 20 into the connector openings 12.

In summary, the present invention relates to a connector device for connecting one or more hydrogen storage means to a fuel cell. Proposed for this purpose is a connector device comprising a main part made of a light metal, such as aluminum, and connector elements made of a high-strength material, such as high-grade steel.

1. A connector device (1) for a high-pressure hydrogen reservoir (2-i), comprising:
a main part (10), which is made of aluminum or an aluminum alloy and has a flow channel (11) and at least one connector opening (12) extending radially to the flow channel (11); and
at least one connector element (20) made of steel,
wherein the at least one connector element (20) is arranged in the at least one connector opening (12) of the main part (10).

2. The connector device (1) according to claim 1, wherein the main part (10) comprises an aluminum cast part.

3. The connector device (1) according to claim 1,
wherein the at least one connector opening (12) has a thread, and
wherein the at least one connector element (20) is screwed into the connector opening (12).

4. The connector device (1) according to claim 3, wherein the at least one connector element (20) comprises a sealing portion (21) that rests upon an outer side of the main part (10) when the connector element (20) is screwed in.

5. The connector device (1) according to claim 3, wherein the thread has a conical shape, and wherein a diameter of the thread in an area of the outer side of the main part (10) is greater than a diameter of the thread in an area of the flow channel (11).

6. The connector device (1) according to claim 1, wherein the at least one connector element (20), on a portion facing away from the main part (10), is configured to be connected to a high-pressure hydrogen reservoir (2-i).

7. A high-pressure hydrogen storage device, comprising:
a connector device (1) according to claim 1; and
at least one high-pressure hydrogen reservoir (2-i), which is in each case releasably connected to the connector device (1) on a connector element (20).

8. A fuel cell system comprising:
a high-pressure hydrogen storage device according to claim 7; and
a fuel cell device which is connected to the high-pressure hydrogen storage device.

9. A manufacturing method for a connector device (1) for a high-pressure hydrogen reservoir, comprising:
providing (S1) a main part (10) made of aluminum or an aluminum alloy having a flow channel (11) and at least one connector opening (12) extending radially to the flow channel (11); and
inserting (S2) at least one connector element (20) made of steel into the at least connector opening (12) of the main part (1).

10. The connector device (1) according to claim 2, wherein the at least one connector opening (12) has a thread, and
wherein the at least one connector element (20) is screwed into the connector opening (12).

11. The connector device (1) according to claim 4, wherein the thread has a conical shape, and wherein a diameter of the thread in an area of the outer side of the main part (10) is greater than a diameter of the thread in an area of the flow channel (11).
